(19) United States
(12) Patent Application Publication
(10) Pub. No.: US 2005/0246861 A1
(43) Pub. Date: Nov. 10, 2005

(54) Baby stroller handle extension

(76) Inventor: Erik Monrad, Berkeley, CA (US)

Correspondence Address: BRUCE & MCCOY, ONE KAISER PLAZA, STE. 750, OAKLAND, CA, 94612, US

(21) Appl. No.: 10/818,687

(22) Filed: Apr. 5, 2004

(51) Int. Cl. B62B 1/00

(52) U.S. Cl. 16/110.1

(57) ABSTRACT

A baby stroller extension handle having three 90 degree bends and being clampable to a baby stroller handle.

### BACKGROUND OF THE INVENTION

1. Field of the Invention

The present invention relates to an attachment apparatus for baby strollers and, more particularly, to the push handles thereof. Still more particularly, the present invention relates to a universal detachable extension for stroller push handles with a multiple of handle position orientations which permits even taller persons to push strollers without mechanical interference occurring between the reciprocating motion of the feet of the pusher and the rear end of the stroller apparatus. Even more particularly, the present invention permits single-handed controlled propulsion of a baby stroller.

Specifically, the present invention relates to an aftermarket baby stroller handle extension which can be clamped to a variety of shapes of baby stroller handles and which permits the stroller pusher to grasp either a perpendicularly rearward projecting bar or alternatively an extended horizontal cross bar for completely controlled, neutral side force, single-handed propelling thereof.

2. Description of the Prior Art

The use of handle extensions in one form or another for the purpose of enhancing the utility of baby strollers is known in the prior art. However, despite the numerous designs, structures, and forms of apparatus disclosed by and utilized in the prior art, which have been developed for the accomplishment of the specific objectives, purposes, and requirements of push handles for the most modern designs of baby strollers, the devices, machines, and apparatus which have been heretofore devised and utilized to accomplish these goals consist basically of familiar, expected, and obvious configurations, combinations, and arrangements of well known apparatus. This will become apparent from the following consideration of the closest known and relevant prior art in comparison with the advantages of the present invention.

The numerous efforts to provide handle extensions for baby strollers as demonstrated by the issued patents of the prior art, illustrate the need for such an apparatus. However, these devices all have certain and different disadvantages. They can be expensive to manufacture whereby they have not achieved commercial success or customer acceptance. They can be of such a design that they can only be utilized with a specific type and design of stroller handle. They can be of such a configuration that they are not suitable for retrofit on pre-manufactured stroller apparatus but must be supplied as original manufacture equipment, and most of the extensions have hand positions which are improperly oriented for the purpose intended or are not of an ergonomically preferred orientation.

Examples of the prior art stroller handle extensions are found in the following patents.

U.S. Pat. No. 5,625,923, issued May 6, 1997, to Huang for Stroller Length-Adjustable Handle discloses a concentric nested tube extension which adjustably telescopes to lengthen the handle. It requires an expensive and complicated locking mechanism to retain the handle extension at the selected length and because of its design cannot be adapted to existing or pre-manufactured handles;

U.S. Pat. No. 5,845,917, issued Dec. 8, 1998, to the same inventor, Huang, is for a Telescopic Handle for a Stroller, the same as his prior patent, but it is of a simpler design. It likewise cannot be adapted to pre-manufactured handles.

U.S. Pat. No. 5,845,916, issued Dec. 8, 1998, to Stroud for Handle for Infant Stroller is of a unique configuration which provides an ergonomically oriented push bar grip configuration but it is not a stroller handle extension.

U.S. Pat. No. 5,988,669, issued Nov. 23, 1999, to Freese et al. for Stroller with Grip Handle also recognizes the need for an ergonomic grip handle for a stroller but it likewise is not a handle extension.

U.S. Pat. No. 6,098,492, issued Aug. 8, 2000, to Juchniewicz et al. for a Device for Extending the Handle of a Wheeled Cart discloses an extension handle which can be secured to certain pre-manufactured designs. However, it provides the same non-ergonomic handle orientation as the pre-existing handle that it extends.

And U.S. Pat. No. 6,101,678, issued Aug. 15, 2000, to Malloy et al. for Adjustable Handle for a Manually Movable Vehicle discloses an adjustable handle for the purpose for raising or lowering its height. It does not extend its length beyond its arc of orientation.

The present invention obtains the best aspects of these devices and overcomes the disadvantages in the above-described prior art apparatus by providing a baby stroller handle extension which permits the stroller pusher to propel and control the direction of a stroller, without stooping, hunching, side-loading, or pushing with the fingertips. It further enables tall stroller pushers to take full strides while propelling a stroller without foot interference or contact with the stroller apparatus. Most importantly, the present invention enables stroller pushers to operate, propel, or motivate a stroller single-handedly with complete directional control.

Thus, the baby stroller handle extension contemplated according to the present invention departs substantially from the conventional concepts and designs taught and used by the prior art and, in doing so, provides an apparatus primarily developed for the purpose of overcoming the problems as described above, but it accomplishes the result in a different and improved manner for permitting single-handed controlled stroller propulsion at a more removed position than standard strollers more conveniently, ergonomically, easily, and economically.

### SUMMARY OF THE INVENTION

In view of the foregoing known, obvious, and described disadvantages inherent in the known types of baby stroller handle extensions presently existing in the prior art, the present invention provides a new apparatus and construction for baby stroller handle extensions wherein the same can be utilized to permit a stroller pusher to propel a stroller single-handed and with complete directional control from a greater removed distance therefrom than a standard stroller handle.

The general construction of the present invention, which will be described hereafter in greater detail, has been designed to provide a new and improved baby stroller handle extension apparatus which has many of the advantages and performs the functions of the prior art of handle extensions mentioned and described above. It is comprised of many novel features and advantages that result in a new handle configuration and apparatus which is not anticipated, rendered obvious, suggested, or even implied by any of the prior art of handle extensions heretofore known, either alone or in any combination thereof.

The present invention is a baby stroller handle extension comprised of a multiple angled bar having an operative end and a clamped opposite end and at least three 90 degree bends in the bar between the ends. The bar includes a first 90 degree bend located in the operative end of the bar and spaced from the adjacent first terminal end thereof. A second 90 degree bend is located generally intermediate the length of the bar and in the same plane as the first 90 degree bend. A third 90 degree bend is located in the clamped end of the bar and in spaced relation from the adjacent second terminal end thereof. The third 90 degree bend is spaced from the second 90 degree bend and from the second terminal end of the bar. The clamped end of the bar lies in a plane perpendicular to the plane of the first and second 90 degree bends. A clamping means is provided for securing the clamped end of the bar to a baby stroller handle.

The more important features of the invention have been broadly outlined in the preceding summary of the invention in order that the detailed description thereof which follows may be better understood and in order that the present contribution to an improvement in the art may be better appreciated. There are additional features of the invention that will be described hereinafter and which will form the subject matter of the claims appended hereto.

With respect to the claims hereof, and before describing at least one preferred embodiment of the invention in detail, it is to be understood that the invention is not to be limited in its application to the details of construction and to the arrangements of the components which are set forth in the following description or illustrated in the accompanying drawings. The invention is capable of being created in other embodiments and of being practiced and carried out in various ways. Also, it is to be understood that the phraseology and terminology employed here are for the purpose of description and should not be regarded as limiting.

As such, those skilled in the art in which the invention is based will appreciate that the conception upon which this disclosure is predicated may readily be utilized as a basis for the designing of other forms, structures, apparatus, systems, and methods for carrying out the several purposes of the present invention. It is important, therefore, that the claims be regarded as including such equivalent constructions in so far as they do not depart from the spirit and scope of the present invention.

Further, the purpose of the appended abstract is to enable the United States Patent and Trademark Office, and the public generally, and especially scientists, engineers and practitioners of the art who are not familiar with the patent and legal terms or phraseology, to determine quickly from cursory inspection the nature and essence of the technical disclosure of the application. The abstract is neither intended to define the invention of the specification, which is measured by the claims, nor is it intended to be limiting as to the scope of the invention in any way.

### OBJECTS OF THE INVENTION

It is therefore an important object of the present invention to provide a new and novel baby stroller handle extension.

It is another object of the present invention to provide a baby stroller handle extension which permits even a tall stroller pusher to propel a stroller without bodily interference with its rear end of the apparatus.

It is a further object of the present invention to provide a baby stroller handle extension of adjustable positioning and orientation which is an aftermarket item that fits a wide variety of stroller handle configurations.

It is still another object of the present invention to provide a baby stroller handle extension which can be easily engaged or quickly detached from a standard stroller handle.

It is yet a further object of the present invention to provide a baby stroller handle extension which includes a multiple of handle orientations which have proven to be preferred and are ergonomically desirable for single-handed operation.

And it is still a further object of the present invention to provide a baby stroller handle extension which permits single-handed, neutral side loading, propulsion of a baby stroller with complete directional control thereof.

Other objects and advantages of the present invention will become apparent when the method and apparatus of the present invention are considered in conjunction with the accompanying drawings.

### DESCRIPTION OF THE DRAWINGS

FIG. 1 is a perspective view of the baby stroller handle extension of the present invention shown secured to a single unit first type of baby stroller handle in the form of an inverted letter J;

FIG. 2 is a perspective view of the baby stroller handle extension of the present invention shown secured to a single unit second type of baby stroller handle in the form of an inverted flat bottom letter U; and

FIG. 3 is an exploded view of the baby stroller handle of the present invention.

### DESCRIPTION OF THE PREFERRED EMBODIMENT

Reference is made to the drawings for a description of the preferred embodiment of the present invention wherein like reference numbers represent like elements on corresponding views.

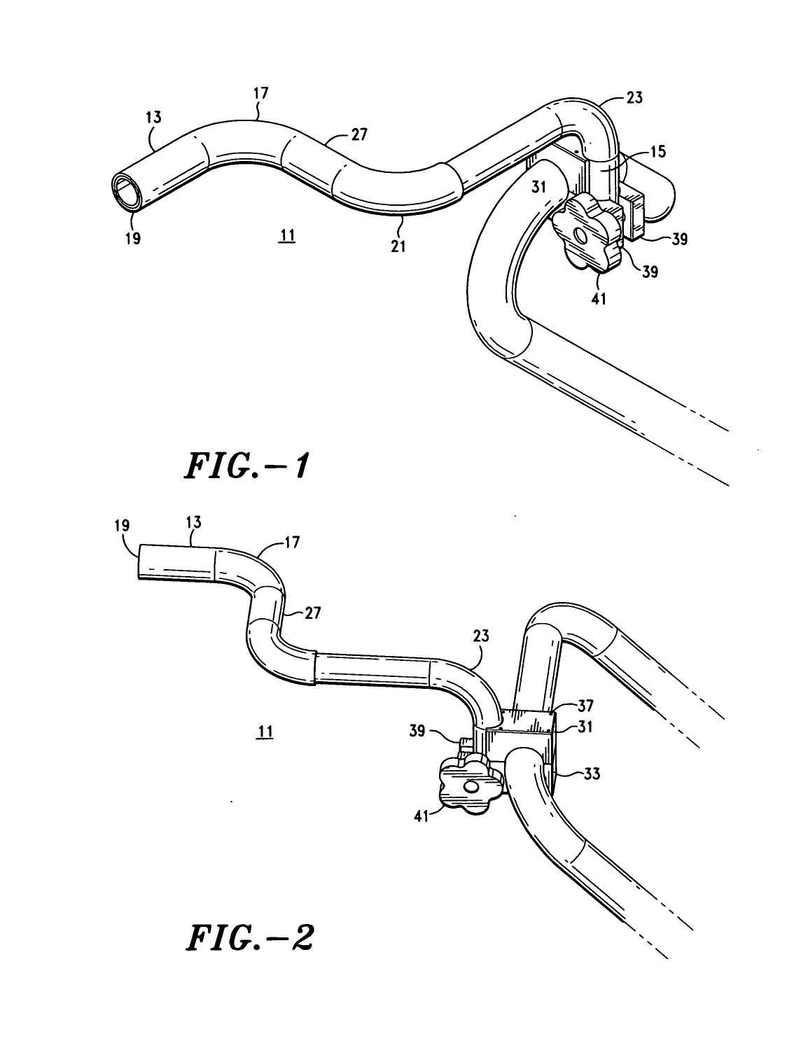

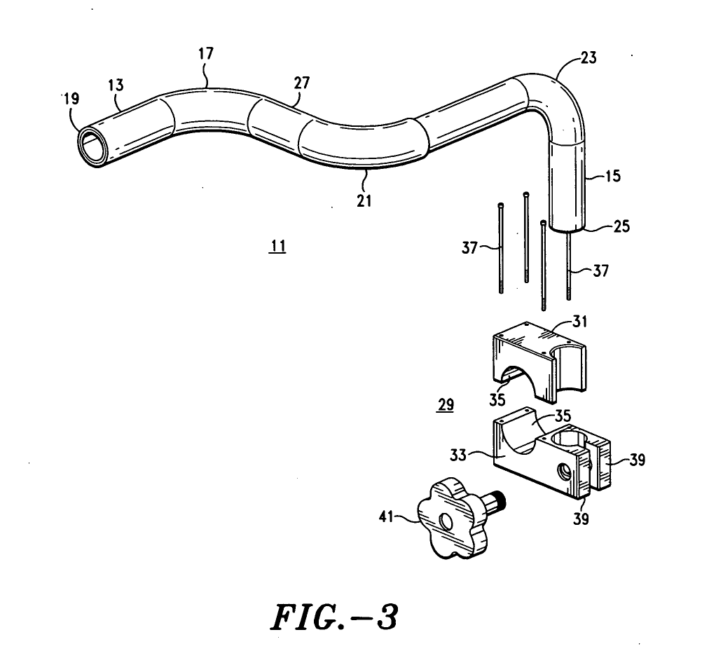

FIGS. 1-3 show the baby stroller handle extension 11 of the present invention which is comprised of a multiple angled bar having an operative end 13 and a clamped opposite end 15. The operative end is the one grasped by the stroller pusher to propel, control, or arrest movement of the stroller. It includes in the present invention the concept of multiple angled separate or distinct grasping sections in the bar, each of which are ergonomically oriented for the ease, comfort, and benefit of the pusher.

The angled bar is created by three 90 degree bends disposed intermediate the length of the bar between the terminal ends thereof. The first 90 degree bend 17 is located in the operative end 13 of the bar in spaced relation from the adjacent first terminal end 19 thereof. The second 90 degree bend 21 is located generally intermediate the length of the bar and in the same plane as the first 90 degree bend.

A third 90 degree bend 23 is located in the clamped end 15 of the bar and in spaced relation from the adjacent second terminal end 25 thereof. The third 90 degree bend is spaced from the second 90 degree bend 21 and from the second terminal end. The clamped end of the bar lies in a plane perpendicular to the plane of the first and second 90 degree bends.

The multiple angled bar results in an ergonomic configuration which, when the bar is appropriately clamped to the stroller handle, has a first terminal end 19, the operative end 13, which can be oriented to project horizontally and perpendicularly rearward from a stroller handle crossbar. If the bar is appropriately clamped to the stroller handle, then intermediate the projecting operative end and the clamped end, between the first and second 90 degree bends, is a horizontally oriented bar section 27 which can be gripped like a push bar. Alternatively, the bar can be rotated 90 degrees in its attachment to the stroller handle, by reclamping on a side bar and switching ends, whereby the intermediate section can be oriented vertically whereby it can be gripped like a pistol grip. The previously-mentioned patent to Stroud shows such a handle orientation, but it is not adjustable in orientation or length and does not provide a rearward projection.

A clamping means is provided for securing the terminal clamped end 15, 25 of the bar to a baby stroller handle. The clamp is a compact universal unit whereby it can be secured to any type of bar and even curved rods or bars. Likewise, it can clamp the bar handle extension of the present invention in a multiple of orientations. The clamping means is comprised of a pair of interlocked integral clamps 29 which can interconnect two bars positioned at right angles to each other. In the preferred embodiment of the invention, at least one of the interlocked clamps has a quick disconnect pressure or friction lock to permit relatively rapid attachment and removal of the handle extension to and from a stroller handle while the other clamp is more permanently affixed to the stroller handle.

The portion of the interlocked clamps which is securable to the stroller handle is comprised of a pair of blocks or pads 31, 33 having opposing half pipe cavities 35 for encircling the handle of a stroller. The cavities can be provided with deformable fillers to permit different diameter rods or tubes and odd configuration bars or rods to be clamped therein. The pads are secured together by fasteners such as pairs of screws 37 disposed on opposite sides of the clamped bar which interconnect the blocks. The screws project through one of the pads and threadably engage the other pad to lock the blocks semi-permanently to the stroller handle. Other fasteners can obviously perform the function.

The second portion of the interlocked clamp is a semi-split block 39 which captures the multiple angled bar of the present invention therein and can be clamped or tightened onto the bar by a hand-tightenable screw threaded stud 41 which extends between the opposing split block extensions. When the stud is tightened, it compresses the split block clamp onto the interposed bar. The releasable clamp also permits the bar to be easily reoriented to preferred ergonomic configurations as well as quickly detached from the stroller handle.

The baby stroller handle extension of the present invention can be positioned to extend rearwardly of the baby stroller in such a manner that the handle portion, which is grasped with one hand by the stroller pusher, is located proximate to the fore and aft centerline of the stroller. This permits the pusher to exert force neutrally to the forward motion of the stroller which eliminates any induced turning torque or side loading. As a result of the rear extension of the handle, further behind the stroller than the standard handle, greater turning torque is provided for controlling the direction of the stroller, thereby making turning the direction of the stroller easier and single-handed operation and control more easily achieved.

Thus, it will be apparent from the foregoing description of the invention in its preferred form that it will fulfill all the objects and advantages attributable thereto. While it is illustrated and described in considerable detail herein, the invention is not to be limited to such details as have been set forth except as may be necessitated by the appended claims.

1. A baby stroller handle extension comprising
a multiple angled bar having an operative end and a clamped opposite end and at least three 90 degree bends in said bar between said ends including
a first 90 degree bend located in said operative end of said bar and spaced from the adjacent first terminal end thereof,
a second 90 degree bend located generally intermediate the length of said bar and in the same plane as said first 90 degree bend,
a third 90 degree bend located in said clamped end of said bar and in spaced relation from the adjacent second terminal end thereof, said third 90 degree bend being spaced from said second 90 degree bend and from said second terminal end of said bar, said clamped end of said bar lying in a plane perpendicular to said plane of said first and second 90 degree bends, and
a clamping means for securing said clamped end of said bar to a baby stroller handle.

2. The baby stroller handle extension of claim 1 wherein said clamping means is comprised of a pair of interlocked clamps which can interconnect two bars positioned at right angles to each other, one bar being said clamped end of said angled bar and the other bar being a portion of the handle of a baby stroller.

3. The baby stroller handle extension of claim 2 wherein at least one of said interlocked clamps has a quick disconnect lock to permit relatively rapid attachment and removal of said handle extension to and from a stroller handle.

4. The baby stroller handle extension of claim 2 wherein a first of said interlocked clamps is securable to a stroller handle by means of two clamping pads which are disposed on opposite sides of said handle and are interconnected by fasteners which adjustably engage one of said pads to the other, said other or second clamping pad is a split block which captures a bar therein and can be tightened on said bar by a hand-tightenable screw threaded stud which extends between the opposing split block extensions and compresses the split block clamp onto the interposed bar.

5. A baby stroller handle extension comprising
a multiple angled bar having an operative end and a clamped opposite end and at least three 90 degree bends in said bar between said ends including
a first 90 degree bend located in said operative end of said bar and spaced from the adjacent first terminal end thereof,
a second 90 degree bend located generally intermediate the length of said bar and in the same plane as said first 90 degree bend,
a third 90 degree bend located in said clamped end of said bar and in spaced relation from the adjacent second terminal end thereof, said third 90 degree bend being spaced from said second 90 degree bend and from said second terminal end of said bar, said clamped end of said bar lying in a plane perpendicular to said plane of said first and second 90 degree bends, and
a clamping means for securing said clamped end of said bar to a baby stroller handle including a pair of interlocked clamps which can interconnect two bars positioned at right angles to each other, one bar being said clamped end of said angled bar and the other bar being a portion of the handle of a baby stroller, a first of said interlocked clamps being securable to a stroller handle by means of two clamping pads which are disposed on opposite sides of said handle and are interconnected by fasteners which adjustably engage one of said pads to the other, and said other or second clamping pad being a split block which captures a bar therein and can be tightened onto said bar by a hand-tightenable screw threaded stud which extends between the opposing split block extensions and compresses the split block clamp onto the interposed bar.
